(19) United States
(12) Patent Application Publication
(10) Pub. No.: US 2025/0008173 A1
(43) Pub. Date: Jan. 2, 2025

(54) SYSTEM AND METHOD FOR DISTRIBUTOR ANALYSIS

(71) Applicant: 17LIVE Japan Inc., Tokyo (JP)

(72) Inventors: Jayneel PAWAR, Tokyo (JP); Hemant MEHTA, Tokyo (JP); Uday Kumar EDUDULA, Tokyo (JP); Ajay Prakash MANGALE, Tokyo (JP); Shih-Che TSENG, Taipei City (TW); Tze-Hsuan LIN, Taipei City (TW); Shao-Tang CHIEN, Taipei City (TW); Chi-Wei LIN, Taipei City (TW); Hsuan MO, Taipei City (TW); Yung-Chi HSU, Taipei City (TW)

(21) Appl. No.: 18/526,355

(22) Filed: Dec. 1, 2023

(30) Foreign Application Priority Data
Jun. 28, 2023 (JP) 2023-105915

(51) Int. Cl. H04N 21/24; H04N 21/2187

(52) U.S. Cl. CPC H04N 21/2407; H04N 21/2187

(57) ABSTRACT

The present disclosure relates to a system and a method for distributor analysis. The method includes: determining a first group of distributors corresponding to a first range of achievement scores; determining a second group of distributors corresponding to a second range of achievement scores; comparing a value of a stream parameter of a distributor from the second group of distributors with an average value of the stream parameter of the first group of distributors; and informing the distributor of a result of the comparing process.

### CROSS-REFERENCE TO RELATED APPLICATIONS

This application is based on and claims the benefit of priority from Japanese Patent Application Serial No. 2023-105915 (filed on Jun. 28, 2023), the contents of which are hereby incorporated by reference in their entirety.

### TECHNICAL FIELD

The present disclosure relates to stream analysis in the streaming field.

### BACKGROUND

Real time interaction on the Internet, such as live streaming service, has become popular in our daily life. There are various platforms or providers providing the service of live streaming, and the competition is fierce. It is important for a platform to provide its users their desired services.

China patent application publication CN113747188A discloses a monitoring system and method for video live broadcast quality.

### SUMMARY

A method according to one embodiment of the present disclosure is a method for distributor analysis being executed by one or a plurality of computers, and includes: determining a first group of distributors corresponding to a first range of achievement scores; determining a second group of distributors corresponding to a second range of achievement scores; comparing a value of a stream parameter of a distributor from the second group of distributors with an average value of the stream parameter of the first group of distributors; and informing the distributor of a result of the comparing process.

A system according to one embodiment of the present disclosure is a system for distributor analysis that includes one or a plurality of processors, and the one or plurality of computer processors execute a machine-readable instruction to perform: determining a first group of distributors corresponding to a first range of achievement scores; determining a second group of distributors corresponding to a second range of achievement scores; comparing a value of a stream parameter of a distributor from the second group of distributors with an average value of the stream parameter of the first group of distributors; and informing the distributor of a result of the comparing process.

A computer-readable medium according to one embodiment of the present disclosure is a non-transitory computer-readable medium including a program for distributor analysis, and the program causes one or a plurality of computers to execute: determining a first group of distributors corresponding to a first range of achievement scores; determining a second group of distributors corresponding to a second range of achievement scores; comparing a value of a stream parameter of a distributor from the second group of distributors with an average value of the stream parameter of the first group of distributors; and informing the distributor of a result of the comparing process.

### BRIEF DESCRIPTION OF THE DRAWINGS

FIG. 1 shows a schematic configuration of a live streaming system 1 according to some embodiments of the present disclosure.

FIG. 2 is a block diagram showing functions and configuration of the user terminal 30 of FIG. 1 according to some embodiments of the present disclosure.

FIG. 3 shows a block diagram illustrating functions and configuration of the server of FIG. 1 according to some embodiments of the present disclosure.

FIG. 4 is a data structure diagram of an example of the stream DB 310 of FIG. 3.

FIG. 5 is a data structure diagram showing an example of the user DB 312 of FIG. 3.

FIG. 6 is a data structure diagram showing an example of the gift DB 314 of FIG.

3.

FIG. 7 is a data structure diagram showing an example of data stored in the user DB 312 of FIG. 3.

FIG. 8 is a data structure diagram showing an example of data stored in the stream parameter DB 350 of FIG. 3.

FIG. 9 is a data structure diagram showing an example of data stored in the analysis result DB 352 of FIG. 3.

FIG. 10 shows an example of notifying a distributor of his/her performance suggestion according to some embodiments of the present disclosure.

FIG. 11 is a data structure diagram showing an example of data stored in the action DB 354 of FIG. 3.

FIG. 12 shows an example of a real time dashboard during a live stream.

FIG. 13 shows an exemplary flow chart illustrating a method according to some embodiments of the present disclosure.

FIG. 14 shows an exemplary flow chart illustrating a method according to some embodiments of the present disclosure.

FIG. 15 is a block diagram showing an example of a hardware configuration of the information processing device according to some embodiments of the present disclosure.

### DESCRIPTION OF THE PREFERRED EMBODIMENTS

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

It is desirable for a content platform to provide tools to its content distributors (or streamers, or livestreamers) that could help the content distributors to review their past performance and to perform better in the future. The present disclosure provides systems or methods to help distributors analyze their own performances, so that the distributors can do better in the next live streaming.

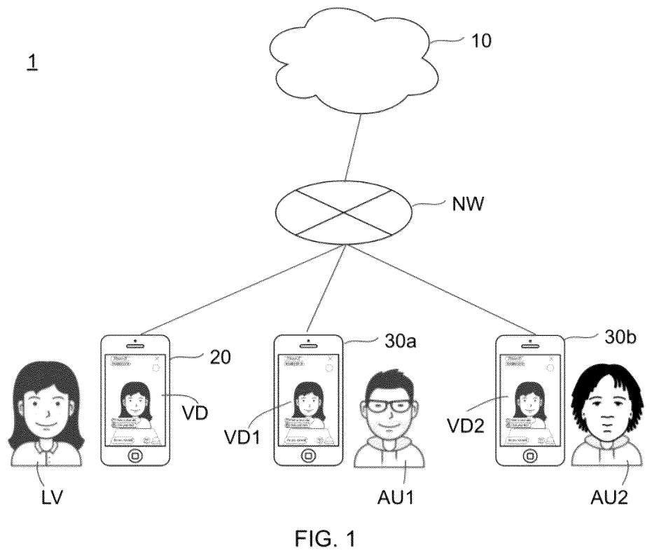

FIG. 1 shows a schematic configuration of a live streaming system 1 according to some embodiments of the present disclosure. The live streaming system 1 provides a live streaming service for the streaming streamer (could be referred to as liver, anchor, distributor, or livestreamer) LV and viewer (could be referred to as audience) AU (AU1, AU2 . . . ) to interact or communicate in real time. As shown in FIG. 1, the live streaming system 1 includes a server 10, a user terminal 20 and user terminals 30 (30a, 30b . . . ). In some embodiments, the streamers and viewers may be collectively referred to as users. The server 10 may include one or a plurality of information processing devices connected to a network NW. The user terminal 20 and 30 may be, for example, mobile terminal devices such as smartphones, tablets, laptop PCs, recorders, portable gaming devices, and wearable devices, or may be stationary devices such as desktop PCs. The server 10, the user terminal 20 and the user terminal 30 are interconnected so as to be able to communicate with each other over the various wired or wireless networks NW.

The live streaming system 1 involves the distributor LV, the viewers AU, and an administrator (or an APP provider, not shown) who manages the server 10. The distributor LV is a person who broadcasts contents in real time by recording the contents with his/her user terminal 20 and uploading them directly or indirectly to the server 10. Examples of the contents may include the distributor's own songs, talks, performances, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or send gifts via the user terminal 30. The distributor LV who is delivering the content may respond to such comments, cheers, or gifts. The response is transmitted to the viewer AU via video and/or audio, thereby establishing an interactive communication.

The term “live-streaming” may mean a mode of data transmission that allows a content recorded at the user terminal 20 of the distributor LV to be played or viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 or 30, and audio data generated using an audio input function of the user terminals 20 or 30. Video data is reproduced in the user terminals 20 and 30, so that the users can view contents. In some embodiments, it is assumed that between video data generation at the distributor's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal and then played back at the viewer's user terminal via the server 10, the video data generated at the distributor's user terminal, the video data that passes through the server 10, and the video data received and reproduced at the viewer's user terminal are all the same video data.

In the example in FIG. 1, the distributor LV provides the live streaming data. The user terminal 20 of the distributor LV generates the streaming data by recording images and sounds of the distributor LV, and the generated data is transmitted to the server 10 over the network NW. At the same time, the user terminal 20 displays a recorded video image VD of the distributor LV on the display of the user terminal 20 to allow the distributor LV to check the live streaming contents currently performed.

The user terminals 30a and 30b of the viewers AU1 and AU2 respectively, who have requested the platform to view the live streaming of the distributor LV, receive video data related to the live streaming (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the contents provided by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond to the comment, the video and sound of the talk are displayed on the user terminals 30a and 30b of the viewers AU1 and AU2, respectively. This interactive action is recognized as the establishment of a conversation between the distributor LV and the viewer AU1. In this way, the live streaming system 1 realizes the live streaming that enables interactive communication, not one-way communication.

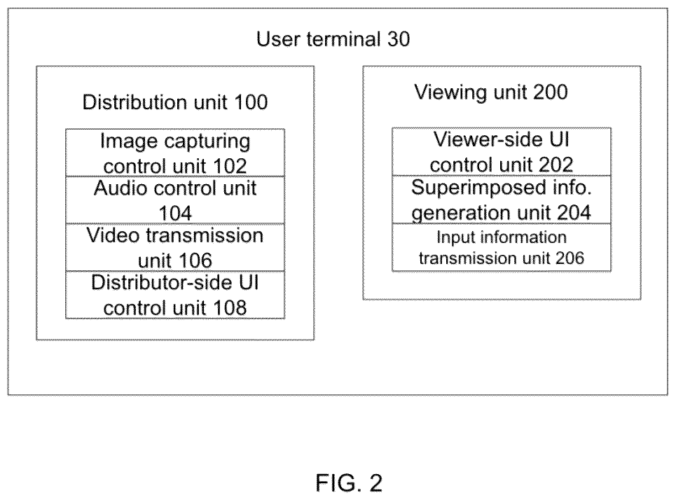

FIG. 2 is a block diagram showing functions and configuration of the user terminal 30 of FIG. 1 according to some embodiments of the present disclosure. The user terminal 20 has the same or similar functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks could be realized by cooperative operation between these elements. Therefore, it is understood by those skilled in the art that these functional blocks can be realized in various forms by combining hardware and software.

The distributor LV and the viewers AU may download and install a live streaming application program (hereinafter referred to as a live streaming application) to the user terminals 20 and 30 from a download site over the network NW. Alternatively, the live streaming application may be pre-installed on the user terminals 20 and 30. When the live streaming application is executed on the user terminals 20 and 30, the user terminals 20 and 30 communicate with the server 10 over the network NW to implement or execute various functions. Hereinafter, the functions implemented by the user terminals 20 and 30 (processors such as CPUs) in which the live streaming application is run will be described as functions of the user terminals 20 and 30. These functions are realized in practice by the live streaming application on the user terminals 20 and 30. In some embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 and a viewing unit 200. The distribution unit 100 generates video data in which the user's (or the user side's) image and sound are recorded, and provides the video data to the server 10. The viewing unit 200 receives video data from the server 10 to reproduce the video data. The user activates the distribution unit 100 when the user performs live streaming, and activates the viewing unit 200 when the user views a video. The user terminal in which the distribution unit 100 is activated is the distributor's terminal, i.e., the user terminal that generates the video data. The user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distribution-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distribution-side UI control unit 108 controls an UI (user interface) for the distributor. The distribution-side UI control unit 108 may be connected to a display (not shown in FIG. 2), and displays a video on the display by reproducing the video data that is to be transmitted by the video transmission unit 106. The distribution-side UI control unit 108 may display an operation object or an instruction-accepting object on the display, and accepts inputs from the distributor who taps on the object.

The viewing unit 200 includes a viewer-side UI control unit 202, a superimposed information generation unit 204, and an input information transmission unit 206. The viewing unit 200 receives, from the server 10 over the network NW, video data related to the live streaming in which the distributor, the viewer who is the user of the user terminal 30, and other viewers participate. The viewer-side UI control unit 202 controls the UI for the viewers. The viewer-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and/or information obtained from the server 10. The input information transmission unit 206 transmits the user input obtained by the viewer-side UI control unit 202 to the server 10 over the network NW.

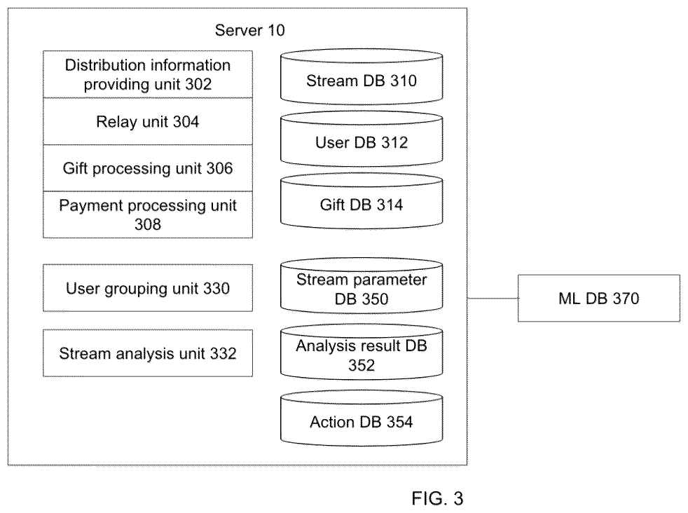

FIG. 3 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, a user grouping unit 330, a stream analysis unit 332, a stream parameter DB 350, an analysis result DB 352, and an action DB 354. The server 10 communicates with a machine learning (ML) DB 370. In some embodiments, the ML DB 370 can be implemented within the server 10.

Upon reception of a notification or a request from the user terminal 20 on the distributor side to start a live streaming over the network NW, the distribution information providing unit 302 registers a stream ID for identifying this live streaming and the distributor ID of the distributor who performs the live streaming in the stream DB 310.

When the distribution information providing unit 302 receives a request to provide information about live streams from the viewing unit 200 of the user terminal 30 on the viewer side over the network NW, the distribution information providing unit 302 retrieves or checks currently available live streams from the stream DB 310 and makes a list of the available live streams. The distribution information providing unit 302 transmits the generated list to the requesting user terminal 30 over the network NW. The viewer-side UI control unit 202 of the requesting user terminal 30 generates a live stream selection screen based on the received list and displays it on the display of the user terminal 30.

Once the input information transmission unit 206 of the user terminal 30 receives the viewer's selection result on the live stream selection screen, the input information transmission unit 206 generates a distribution request including the stream ID of the selected live stream, and transmits the request to the server 10 over the network NW. The distribution information providing unit 302 starts providing, to the requesting user terminal 30, the live stream specified by the stream ID included in the received distribution request. The distribution information providing unit 302 updates the stream DB 310 to include the user ID of the viewer of the requesting user terminal 30 into the viewer IDs of (or corresponding to) the stream ID.

The relay unit 304 relays the video data from the distributor-side user terminal 20 to the viewer-side user terminal 30 in the live streaming started by the distribution information providing unit 302. The relay unit 304 receives from the input information transmission unit 206 a signal that represents user input by a viewer during the live streaming or reproduction of the video data. The signal that represents user input may be an object specifying signal for specifying an object displayed on the display of the user terminal 30. The object specifying signal may include the viewer ID of the viewer, the distributor ID of the distributor of the live stream that the viewer watches, and an object ID that identifies the object. When the object is a gift, the object ID is the gift ID. Similarly, the relay unit 304 receives, from the distribution unit 100 of the user terminal 20, a signal that represents user input performed by the distributor during reproduction of the video data (or during the live streaming). The signal could be an object specifying signal.

Alternatively, the signal that represents user input may be a comment input signal including a comment entered by a viewer into the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side UI control unit 202 and the superimposed information generation unit 204 display the received comment on the display in association with the viewer ID also received.

The gift processing unit 306 updates the user DB 312 so as to increase the points of the distributor depending on the points of the gift identified by the gift ID included in the object specifying signal. Specifically, the gift processing unit 306 refers to the gift DB 314 to specify the points to be granted for the gift ID included in the received object specifying signal. The gift processing unit 306 then updates the user DB 312 to add the determined points to the points of (or corresponding to) the distributor ID included in the object specifying signal.

The payment processing unit 308 processes payment of a price of a gift from a viewer in response to reception of the object specifying signal. Specifically, the payment processing unit 308 refers to the gift DB 314 to specify the price points of the gift identified by the gift ID included in the object specifying signal. The payment processing unit 308 then updates the user DB 312 to subtract the specified price points from the points of the viewer identified by the viewer ID included in the object specifying signal.

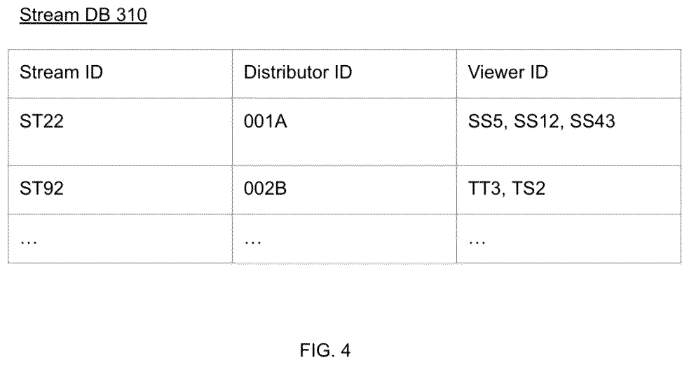

FIG. 4 is a data structure diagram of an example of the stream DB 310 of FIG. 3. The stream DB 310 holds information regarding a live stream currently taking place. The stream DB 310 stores the stream ID, the distributor ID, and the viewer ID, in association with each other. The stream ID is for identifying a live stream on a live streaming platform provided by the live streaming system 1. The distributor ID is a user ID for identifying the distributor who provides the live stream. The viewer ID is a user ID for identifying a viewer of the live stream. In the live streaming platform provided by the live streaming system 1 of some embodiments, when a user starts a live stream, the user becomes a distributor, and when the same user views a live stream broadcast by another user, the user also becomes a viewer. Therefore, the distinction between a distributor and a viewer is not fixed, and a user ID registered as a distributor ID at one time may be registered as a viewer ID at another time.

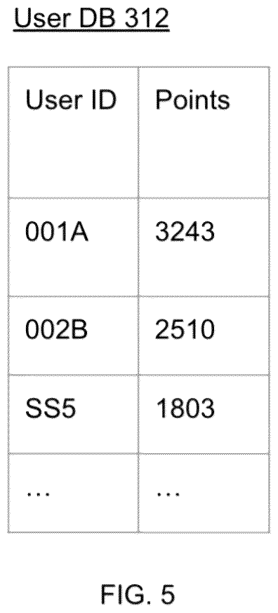

FIG. 5 is a data structure diagram showing an example of the user DB 312 of FIG. 3. The user DB 312 holds information regarding users. The user DB 312 stores the user ID and the point, in association with each other. The user ID identifies a user. The point corresponds to the points the corresponding user holds. The point is the electronic value circulated within the live streaming platform. In some embodiments, when a distributor receives a gift from a viewer during a live stream, the distributor's points increase by the value corresponding to the gift. The points are used, for example, to determine the amount of reward (such as money) the distributor receives from the administrator of the live streaming platform. In some embodiments, when the distributor receives a gift from a viewer, the distributor may be given the amount of money corresponding to the gift instead of the points.

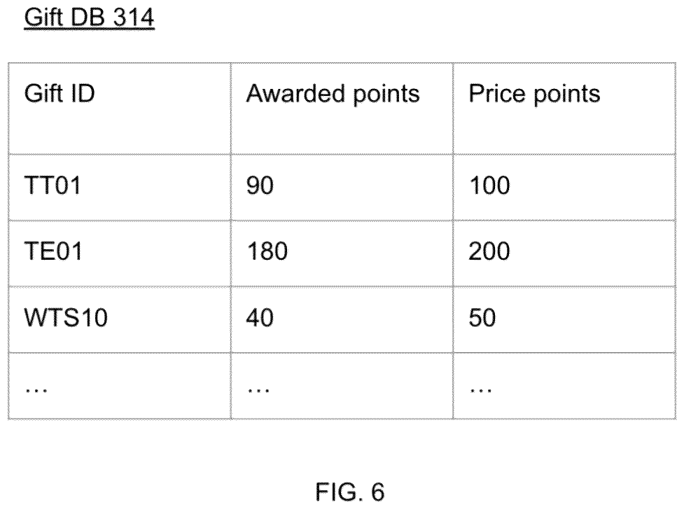

FIG. 6 is a data structure diagram showing an example of the gift DB 314 of FIG. 3. The gift DB 314 holds information regarding gifts available for the viewers in the live streaming. A gift is electronic data. A gift may be purchased with the points or money, or can be given for free. A gift may be given by a viewer to a distributor. Giving a gift to a distributor is also referred to as using, sending, or throwing the gift. Some gifts may be purchased and used at the same time, and some gifts may be purchased and then used at any time later by the purchaser viewer. When a viewer gives a gift to a distributor, the distributor is awarded the amount of points corresponding to the gift. When a gift is used, the use may trigger an effect associated with the gift. For example, an effect (such as visual or sound effect) corresponding to the gift will appear on the live streaming screen.

The gift DB 314 stores the gift ID, the awarded points, and the price points, in association with each other. The gift ID is for identifying a gift. The awarded points are the amount of points awarded to a distributor when the gift is given to the distributor. The price points are the amount of points to be paid for use (or purchase) of the gift. A viewer is able to give a desired gift to a distributor by paying the price points of the desired gift when the viewer is viewing the live stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 1.2 may be set as the price points, or points obtained by adding predetermined fee points to the awarded points may be set as the price points.

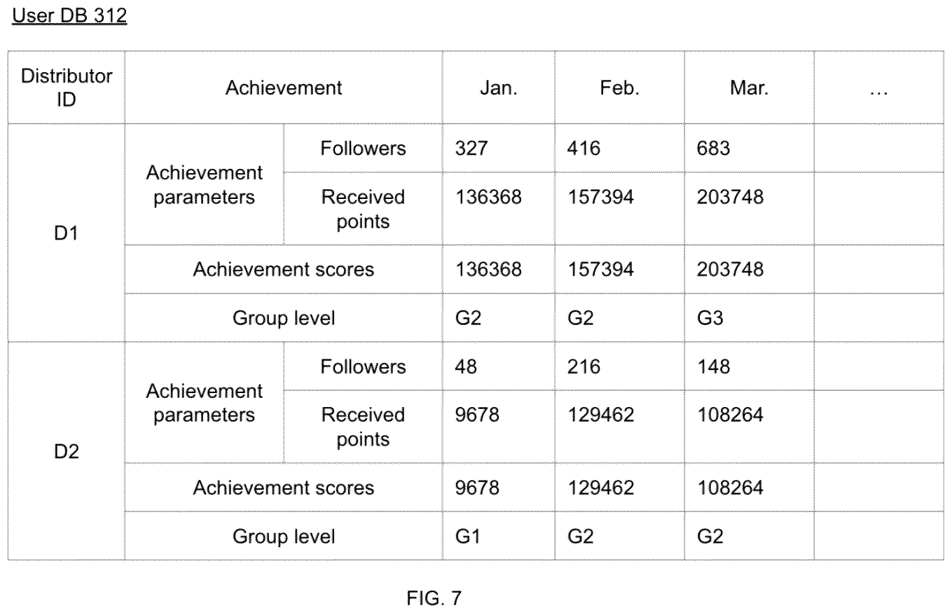

FIG. 7 is a data structure diagram showing an example of data stored in the user DB 312 of FIG. 3. The user DB 312 stores the distributor ID, the achievement parameters, the achievement scores, the group level, the time sequence, in association with each other. In this embodiment, the achievement parameters include the followers and the received points for the distributor. In some embodiments, the achievement parameters may include other metrics such as revenue contributed by the corresponding distributor. The achievement scores are calculated from the achievement parameters. In this embodiment, the achievement score is set to be equal to the received points. In other embodiments, the achievement score could be set according to actual practice or the focus point of the operator of the streaming platform. For example, the achievement score may increase as one or more achievement parameters increase. For example, the achievement score may be proportional to one or more achievement parameters. For example, the achievement score may be a weighted sum of the achievement parameters.

The group level corresponds to the grouping result for the distributor in a specific time, and is determined according to the achievement scores. For example, in this embodiment, group level G1 corresponds to achievement scores with the range 0 to 9999, group level G2 corresponds to achievement scores with the range 10000 to 19999, group level G3 corresponds to achievement scores with the range 20000 to 29999. The grouping process could be performed by the user grouping unit 330.

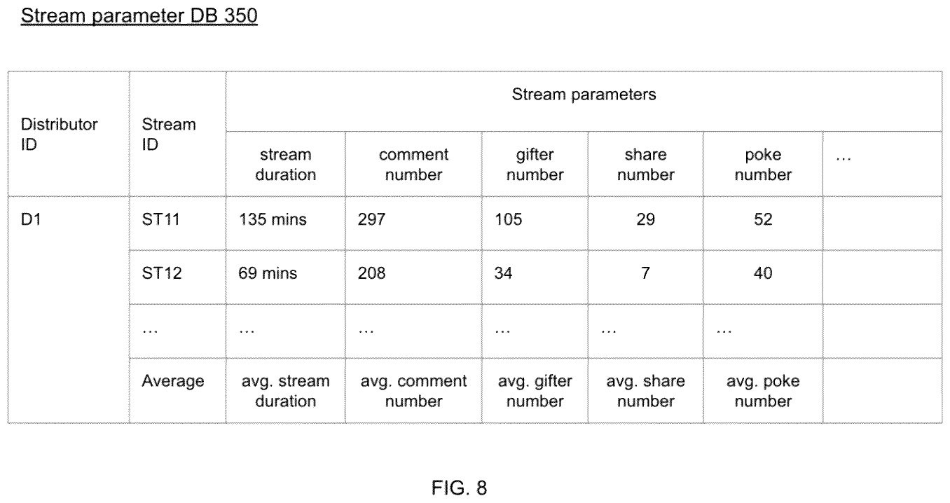

FIG. 8 is a data structure diagram showing an example of data stored in the stream parameter DB 350 of FIG. 3. The stream parameter DB 350 stores the distributor ID, the stream ID, the stream parameters, in association with each other. The stream parameters may include stream duration, number of comments from viewers during the stream, viewer click count, number of gifting viewers (or gifters) during the stream, number of sharing actions of viewers during the stream, number of poking actions of the distributor (with respect to viewers) during the stream, number of following actions of the viewers during the stream, number of commenters during the stream, number of viewers viewing longer than a predetermined time during the stream, thumbnail data of the stream (e.g., image data, or click rate of the thumbnail), streaming timing of the stream, etc. In some embodiments, the stream parameters may include absence duration of the distributor, which indicates how long the distributor has not performed streaming. In some embodiments, the stream parameters may include any of the above factors in a predetermined time period.

As shown in FIG. 8, the average number of each stream parameter could also be calculated. The calculation could be performed with respect to a predetermined time period. For example, streams performed by the distributor within one week or within one month could be taken into the calculation.

The user grouping unit 330 is configured to divide or separate users into different groups according to their respective achievement scores. For example, the user grouping unit 330 may determine a first group of distributors whose achievement scores correspond to a first range (such as a higher range). The user grouping unit 330 may determine a second group of distributors whose achievement scores correspond to a second range (such as a lower range). For example, the first group of distributors may have more followers and/or more received points. The second group of distributors may have fewer followers and/or less received points. The result of the grouping process could be stored into the user DB 312 as shown in FIG. 7.

The stream analysis unit 332 is configured to analyze the performance of the distributor (or the streams of the distributor). The stream analysis unit 332 is configured to advise on the performance (or performance direction) of the distributor according to the analysis result. The analysis may be done according to achievement scores of the distributor, stream parameters of streams performed by the distributor, achievement scores of other distributors and/or stream parameters of streams performed by other distributors.

For example, the stream analysis unit 332 compares a value of a stream parameter of a distributor D1, who is from the second group of distributors (with lower achievement scores), with an average value of the stream parameter of the first group of distributors (with greater achievement scores). The value of the stream parameter of distributor D1 could be, for example, an average value calculated from multiple streams performed by distributor D1. The stream analysis unit 332 then informs distributor D1 of a result of the comparing process, to let distributor D1 know the direction he/she could work more on to improve achievement scores. The analysis result could be stored into the analysis result DB 352.

In some embodiments, the informing process may include displaying a difference between the value of the stream parameter of distributor D1 and the average value of the stream parameter of the first group of distributors after distributor D1 finishes a stream. In some embodiments, the informing process may include displaying a difference between a real time value of the stream parameter, during a live stream of distributor D1, and the average value of the stream parameter of the first group of distributors. Therefore, distributor D1 can have a real time understanding of how he/she improves the stream parameter to approach the performance of distributors with higher achievement scores (e.g., the first group of distributors). In some embodiments, the informing process could involve sending a notification to distributor D1 regarding the above comparing results. For example, the stream analysis unit 332 may send a notification request to a notification unit (within or outside server 10) to perform the notification process.

In some embodiments, the informing process may include providing action suggestions to the distributor. For example, the stream analysis unit 332 may refer to the action DB 354 for the action suggestions, and display (or send a notification) to the distributor to help him/her improve.

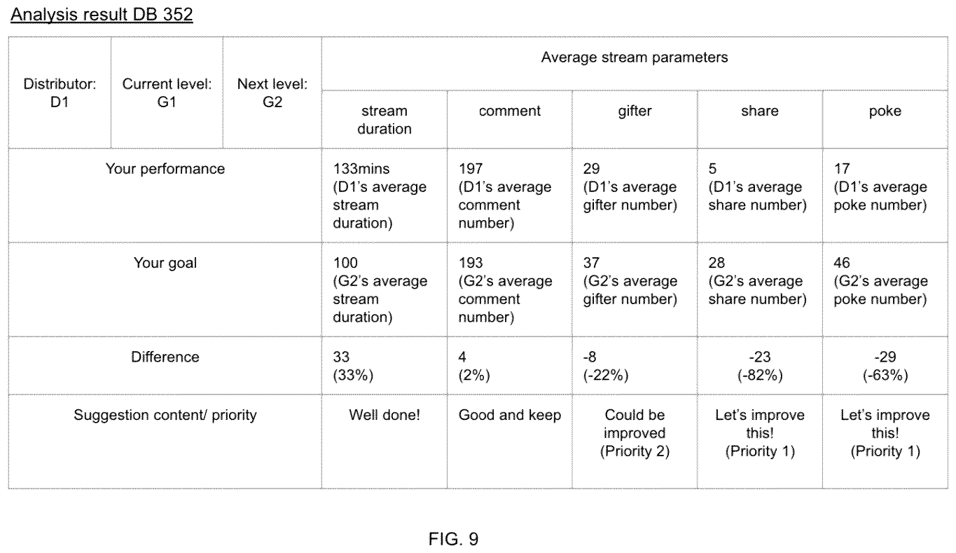

FIG. 9 is a data structure diagram showing an example of data stored in the analysis result DB 352 of FIG. 3. The analysis result DB 352 stores the distributor ID, the current level, the next level, the current performance numbers, the target numbers (goals), the difference, the suggestions, in association with each other.

As shown in FIG. 9, for distributor D1, the current level is G1 and the next level (or target level) is G2. The stream parameters in the row of “your performance” show the average number of each stream parameter for distributor D1, which may be calculated according to stream parameters of multiple streams performed by distributor D1. The stream parameters in the row of “your goal” show the average number of each stream parameter for group level G2, which may be calculated according to average stream parameters of distributors in group level G2. The row “difference” shows the difference between the row “your performance” and the row “your goal”. The row “suggestion/comment” shows the performance suggestions for distributor D1 according to the difference of each stream parameter. The suggestions could include suggestion contents and/or suggestion priorities.

The “difference” could be expressed in values or in percentages (compared with the goal). There could be threshold values defined for the difference. The threshold values could be used to determine the suggestion contents or suggestion priorities. For example, a threshold value of 50% could be defined for the difference such that, a difference (or negative difference) greater than 50% results in a priority 1 suggestion for the corresponding stream parameter. For example, another threshold value of 20% could be defined for the difference such that, a difference (or negative difference) between 20% and 50% results in a priority 2 suggestion for the corresponding stream parameter. As shown in FIG. 9, distributor D1 lacks behind G2 by over 50% in the stream parameters “share” and “poke”, therefore the two parameters are indicated as priority 1 to improve.

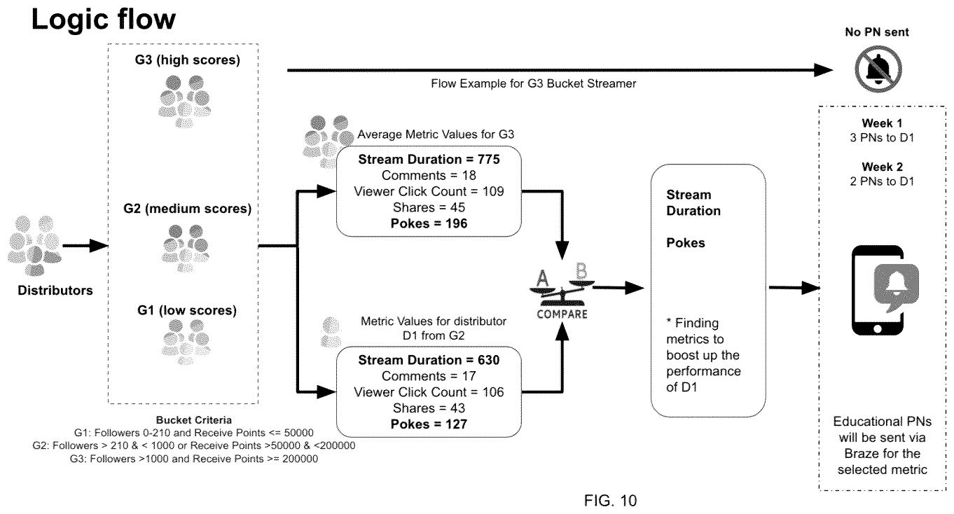

FIG. 10 shows an example of notifying a distributor of his/her performance suggestion according to some embodiments of the present disclosure.

As shown in FIG. 10, distributors are separated into groups (or group levels, or buckets) G3 (with high achievement scores), G2 (with medium achievement scores) and G1 (with low achievement scores). The “bucket criteria” indicates the respective criterion for each level. For the distributors in G3, no educational push notifications (PN) regarding performance suggestions will be sent. For a distributor D1 from G2, the performance analysis has been done based on distributor D1's metric values (or stream parameters) and average metric values for distributors in G3. The stream analysis unit 332 performs the comparison and finds out the metrics to boost up the performance of distributor D1, which are “stream duration” and “pokes”. Subsequently, educational push notifications regarding the analysis results are sent to D1, through Braze notifying service, for example. Therefore, distributor D1 can know which areas to improve to approach the next level. For example, distributor D1 may need to lengthen his/her stream duration. For example, distributor D1 may need to poke his/her viewers more frequently during streaming.

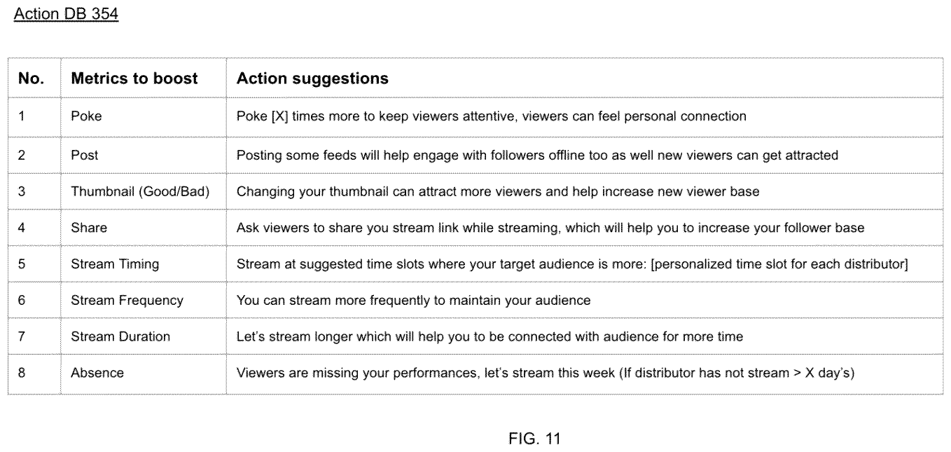

FIG. 11 is a data structure diagram showing an example of data stored in the action DB 354 of FIG. 3. The action DB 354 stores the metrics (or stream parameters) and the suggested actions, in association with each other.

For example, the stream analysis unit 332 compares the stream parameters between distributor D1 and the next group level, and determines that distributor D1 has a relatively bad thumbnail. In some embodiments, a bad thumbnail could mean a lower click rate. A click rate could be defined as [number of times the thumbnail is clicked] divided by [number of times the thumbnail is shown to viewers]. In some embodiments, a thumbnail could be determined to be bad by a machine learning model (e.g., stored in the ML DB 370) according to its image data. The stream analysis unit 332 may then display the message “Changing your thumbnail can attract more viewers and help increase new viewer base” to distributor D1.

For example, the stream analysis unit 332 compares the stream parameters between distributor D1 and the next group level, and determines that distributor D1 has relatively bad stream timings. A bad stream timing could mean a timing when there are fewer target viewers (with respect to distributor D1) on the platform. In some embodiments, a stream timing could be determined to be bad by a machine learning model (e.g., stored in the ML DB 370) according to attribute data and/or viewing history of the viewers. The stream analysis unit 332 may then display the message “Stream at suggested time slots where your target audience is more: [personalized time slot for each distributor]” to distributor D1. The personalized time slot for each distributor could be determined by the machine learning model.

For example, the stream analysis unit 332 compares the stream parameters between distributor D1 and the next group level, and determines that distributor D1 has relatively longer absence duration (or, longer than a threshold X days, for example). The stream analysis unit 332 may then display the message “Viewers are missing your performances, let's stream this week” to distributor D1.

In some embodiments, the stream analysis unit 332 determines correlation between stream parameters and achievement scores, by utilizing machine learning models in the ML DB 370, for example. For example, correlation values between stream parameters and achievement scores in a group level with higher achievement scores can be calculated to find out the crucial stream parameter that results in the high achievement scores. The stream analysis unit 332 then utilizes the correlation result to decide the action to be suggested to the distributor.

For example, the stream analysis unit 332 compares the stream parameters between distributor D1 and the next group level (or higher group level), and determines that distributor D1 has shorter stream durations and less poking numbers. The stream analysis unit 332 then utilizes the correlation data to determine that poking has a higher correlation or a more crucial effect (compared with stream duration) to the high achievement scores in the next group level. Therefore, the stream analysis unit 332 suggests action to increase poking numbers to distributor D1 with a higher priority.

In some embodiments, data in the analysis result DB 352 could be displayed as a performance dashboard for the corresponding distributor. For example, FIG. 9 (or a portion of FIG. 9) could be displayed as a performance dashboard for distributor D1. Distributor D1 may choose or pin whichever stream parameter onto the dashboard to focus on. In some embodiments, the stream parameter values in “your performance” could be real time values in a live stream being performed by distributor D1. The “difference” and the “suggestion content” may vary in a real time manner according to the real time values in “your performance”.

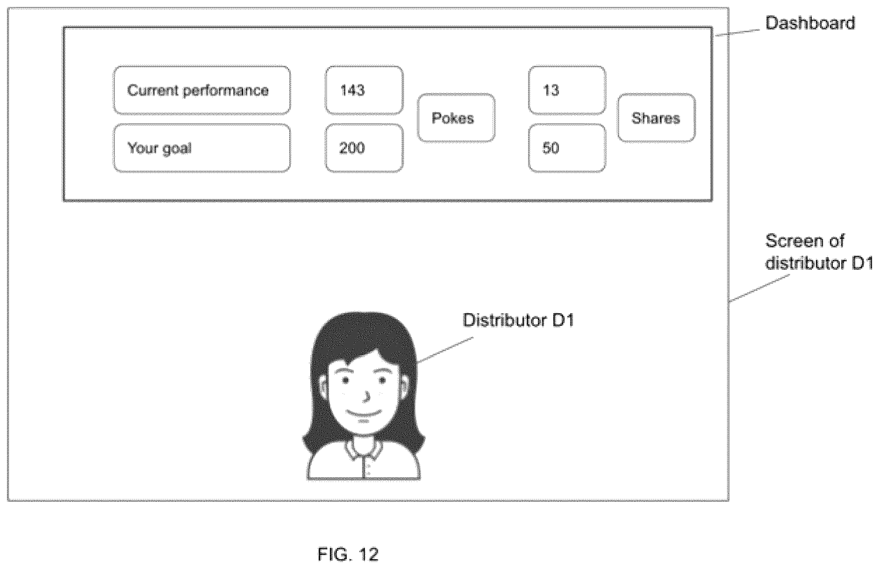

FIG. 12 shows an example of a real time dashboard during a live stream. Distributor D1 sets the stream parameters “Poke” and “Share” onto the dashboard in the live stream. The dashboard can help the distributor to better focus on improving the crucial stream parameters. In some embodiments, the displayed parameters could be set by the stream analysis unit 332 according to the stream analysis result.

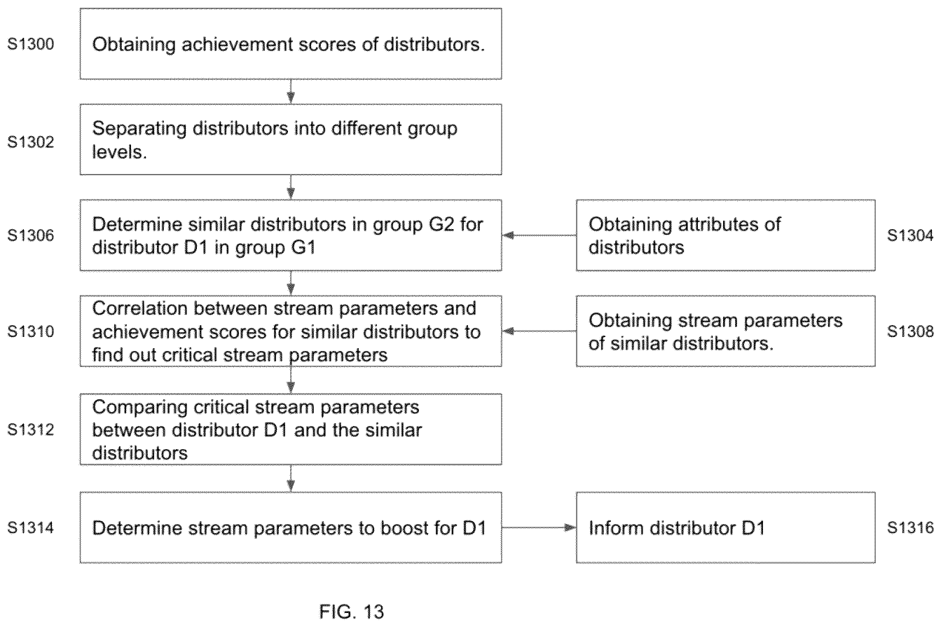

FIG. 13 shows an exemplary flow chart illustrating a method according to some embodiments of the present disclosure.

At step S1300, achievement scores of distributors are obtained or calculated (from achievement parameters of distributors).

At step S1302, distributors are separated into different group levels according to their achievement scores by the user grouping unit 330.

At step S1304, attributes of distributors are obtained. The attributes include information such as gender, location (or country), language, time zone, stream genre, stream topic, streaming time, follower types (or type distribution), viewer types (or viewer distribution) of the distributors. The attribute data could be stored in the user DB 312, for example.

At step S1306, with respect to a distributor D1 in group G1 (with lower achievement scores), similar distributors in group G2 (with higher achievement scores) are determined (by the user grouping unit 330, for example). Similar distributors have one or more attributes similar to (or the same as) distributor D1. Similarity matching or vector matching could be performed, by the ML model 370, for example.

At step S1308, stream parameters of the similar distributors are obtained.

At step S1310, correlation values between stream parameters and achievement scores are calculated for similar distributors to find out critical stream parameters that contribute to their high achievement scores. The process may be performed by the stream analysis unit 332, for example.

At step S1312, values of the critical stream parameters are compared between distributor D1 and the similar distributors.

At step S1314, stream parameters to boost for distributor D1 are determined, according to the comparing result in step S1312.

At step S1316, distributor D1 is informed of the comparing result and/or the stream parameters to boost.

The similar distributors may have more common audiences or more similar audiences with distributor D1. Therefore, by identifying the similar distributors, the resulting parameters can be more precise in helping distributor D1 to improve his/her achievement scores.

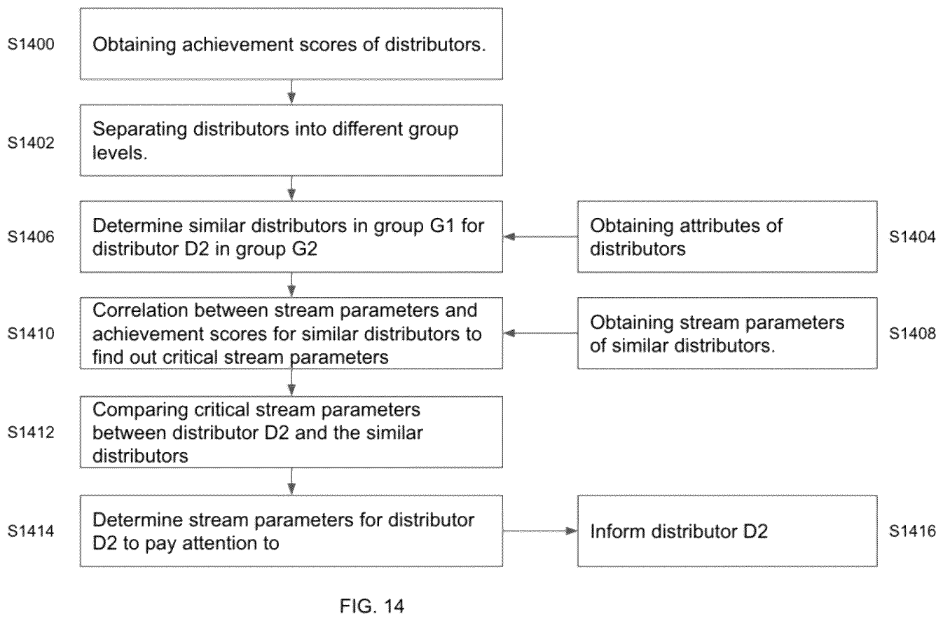

FIG. 14 shows an exemplary flow chart illustrating a method according to some embodiments of the present disclosure.

At step S1400, achievement scores of distributors are obtained or calculated (from achievement parameters of distributors).

At step S1402, distributors are separated into different group levels according to their achievement scores by the user grouping unit 330.

At step S1404, attributes of distributors are obtained.

At step S1406, with respect to a distributor D2 in group G2 (with higher achievement scores), similar distributors in group G1 (with lower achievement scores) are determined (by the user grouping unit 330, for example). Similar distributors have one or more attributes similar to (or the same as) distributor D2. Similarity matching or vector matching could be performed, by the ML model 370, for example.

At step S1408, stream parameters of the similar distributors are obtained.

At step S1410, correlation values between stream parameters and achievement scores are calculated for the similar distributors to find out critical stream parameters that result in their low achievement scores. The process may be performed by the stream analysis unit 332, for example.

At step S1412, values of the critical stream parameters are compared between distributor D2 and the similar distributors.

At step S1414, stream parameters for distributor D2 to pay attention to are determined, according to the comparing result in step S1412.

At step S1416, distributor D2 is informed of the comparing result and/or the stream parameters to pay attention to.

For example, a low stream frequency is determined to be a critical factor that results in the low achievement scores for distributors in G1 in step S1410. Then, when the stream frequency of distributor D2 drops or approaches the average stream frequency of G1, distributor D2 will be notified with a warning to avoid reducing (or to keep) the stream frequency.

In many circumstances, the stream parameter for a distributor to boost (or to focus on) in order to enter a higher level may not be the same as the stream parameter which the distributor needs to be cautious about in order not to fall to a lower level. When a distributor focuses on increasing his level, he may not be aware of what keeps him/her in current level (or what keeps him/her from falling to a lower level). The present disclosure can provide the action target for the distributor to increase the level (increase the achievement scores), and also can provide the warning for the distributor not to step back (to decrease the achievement scores).

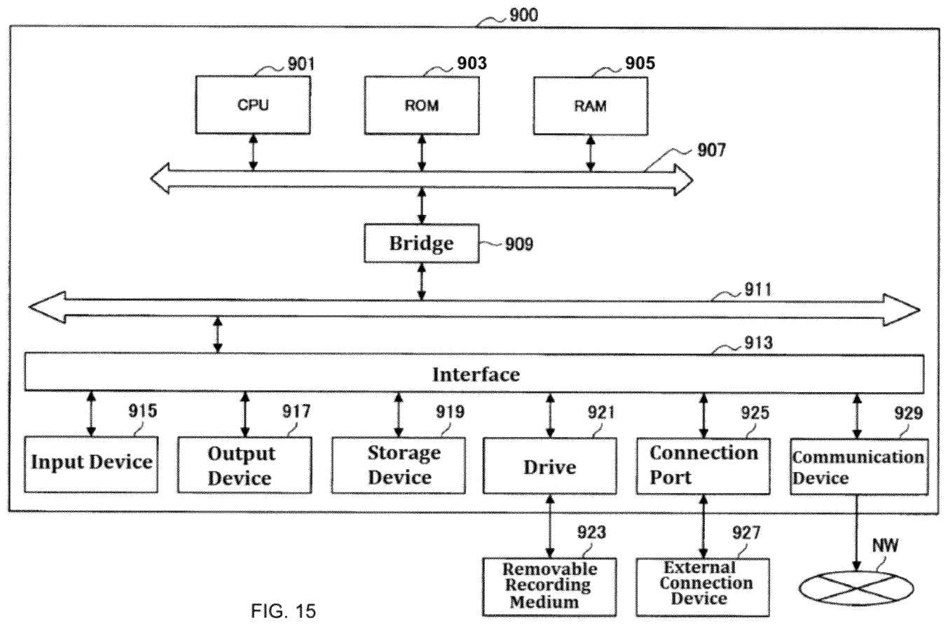

Referring to FIG. 15, the hardware configuration of the information processing device will be now described. FIG. 15 is a block diagram showing an example of a hardware configuration of the information processing device according to some embodiments of the present disclosure. The illustrated information processing device 900 may, for example, realize the server 10 and/or the user terminals 20 and 30 in some embodiments.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in some embodiments. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect/Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OLED, etc., a sound output device such as a speaker and headphones, and a printer. The output device 917 outputs the results of processing by the information processing unit 900 as text, video such as images, or sound such as audio.

The storage device 919 is a device for storing data configured as an example of a storage unit of the information processing equipment 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the live streaming system 1 in the embodiment have been described. This embodiment is a mere example, and it is understood by those skilled in the art that various modifications are possible for each component and a combination of each process, and that such modifications are also within the scope of the present disclosure.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

What is claimed is:

1. A method for distributor analysis on a streaming platform, executed by a server, comprising:
determining a first group of distributors corresponding to a first range of achievement scores;
determining a second group of distributors corresponding to a second range of achievement scores;
comparing a value of a stream parameter of a distributor from the second group of distributors with an average value of the stream parameter of the first group of distributors; and
informing the distributor of a result of the comparing process.

2. The method according to claim 1, wherein an achievement score of a first distributor increases as a number of followers of the first distributor increases or as a number of received points of the first distributor increases.

3. The method according to claim 1, wherein the stream parameter corresponds to average duration per stream, average comment number per stream, average gifter number per stream, average share number per stream, average poke number per stream, average commenter number per stream, or average number of viewers viewing longer than a predetermined time length per stream.

4. The method according to claim 1, further comprising:
determining the stream parameter to have a correlation with the first range of achievement scores by a machine learning model according to values of the stream parameter of the first group of distributors and the first range of achievement scores.

5. The method according to claim 1, wherein the informing process includes displaying, during a live stream of the distributor from the second group of distributors, a difference between a real time value of the stream parameter of the distributor and an average value of the stream parameter of the first group of distributors.

6. The method according to claim 1, further comprising:
determining the first group of distributors and the distributor from the second group of distributors to have the same attribute.

7. The method according to claim 1, wherein the first range of achievement scores are higher than the second range of achievement scores, and the result includes an action suggestion for the distributor to increase the stream parameter of the distributor.

8. The method according to claim 1, wherein the first range of achievement scores are lower than the second range of achievement scores, and the result includes a warning for the distributor to avoid reducing the stream parameter of the distributor.

9. A system for distributor analysis, comprising one or a plurality of processors, wherein the one or plurality of processors execute a machine-readable instruction to perform:
determining a first group of distributors corresponding to a first range of achievement scores;
determining a second group of distributors corresponding to a second range of achievement scores;
comparing a value of a stream parameter of a distributor from the second group of distributors with an average value of the stream parameter of the first group of distributors; and
informing the distributor of a result of the comparing process.

10. A non-transitory computer-readable medium including a program for distributor analysis, wherein the program causes one or a plurality of computers to execute:
determining a first group of distributors corresponding to a first range of achievement scores;
determining a second group of distributors corresponding to a second range of achievement scores;
comparing a value of a stream parameter of a distributor from the second group of distributors with an average value of the stream parameter of the first group of distributors; and
informing the distributor of a result of the comparing process.
